(19) United States
(12) Patent Application Publication
(10) Pub. No.: US 2025/0115131 A1
(43) Pub. Date: Apr. 10, 2025

(54) ELECTRIC VEHICLE OR HYBRID VEHICLE

(71) Applicant: Dr. Ing. h. c. F. Porsche AG, Stuttgart (DE)

(72) Inventors: Dominik Scherer, Stuttgart (DE); Christian Holler, Leonberg (DE)

(73) Assignee: Dr. Ing. h. c. F. Porsche AG, Stuttgart (DE)

(21) Appl. No.: 18/906,755

(22) Filed: Oct. 4, 2024

(30) Foreign Application Priority Data
Oct. 5, 2023 (DE) 10 2023 127 165.2

(51) Int. Cl. B60L 3/00; B60L 50/64; B60L 58/26; H01M 10/46

(52) U.S. Cl. CPC B60L 3/0007; B60L 50/64; B60L 58/26; H01M 10/46; H01M 2220/20

(57) ABSTRACT

An electric vehicle or hybrid vehicle (1) has an inductive charging device (2) and a battery (3) chargeable therewith. The inductive charging device (2) has at least one catch element (4), via which it is connected to a vehicle body (5). The inductive charging device (2) is configured to be ejected from the electric vehicle or hybrid vehicle (1) in the event of a crash and to be held outside the electric vehicle or hybrid vehicle (1) via the at least one catch element (4).

### CROSS-REFERENCE TO RELATED APPLICATION

This application claims priority on German Patent Application No 10 2023 127 165.2 filed Oct. 5, 2023, the entire disclosure of which is incorporated herein by reference.

### FIELD OF THE INVENTION

The invention relates to an electric vehicle or hybrid vehicle having an inductive charging device and a battery chargeable therewith.

### BACKGROUND OF THE INVENTION

DE 10 2019 200 818 A1 discloses a motor vehicle having a battery and an inductive charging device. An auxiliary frame cross-beam is arranged in front of the inductive charging device relative to the direction of travel of the motor vehicle and has a longitudinal extension in a direction perpendicular to the direction of travel. An accident can cause a movement of the auxiliary frame cross-beam opposite the direction of travel, and such movement can cause the subframe cross-member to exert a force on the side of the inductive charging device facing the subframe cross-member. Accordingly, sides of the auxiliary frame cross-beam and the inductive charging device that face one another are configured such that, a movement of the auxiliary frame cross-beam opposite the direction of travel due to an accident will cause the inductive charging device to move down with the intent of improving the crash properties of the motor vehicle.

U.S. Pat. No. 11,970,211 discloses a motor vehicle that comprises a carrier structure and a charging module fixed to the carrier structure at spaced apart connecting elements. A target buckle region is arranged between the connecting elements. The carrier structure is configured to buckle in certain areas and to press on the charging module in the event of accident-related deformation at the target buckling area. This pressing is intended to release a first connection between the charging module and the carrier structure formed by the connecting elements, and this release is intended to provide better protection for the charging module in the event of a crash.

DE 10 2014 004 948 A1 discloses a holder arrangement of a battery on a body of a motor vehicle in which the battery is arranged below a rear floor of the body and held thereon by a guiding device. The guiding device is intended to transfer the battery from an initial position to a protected position in the event of an accident-related force acting from the rear to the front in the longitudinal direction of the vehicle.

US 2022/0194472 A1 and US 2021/0370782 A1 disclose electric vehicles or hybrid vehicles with deformation structures to protect their charging modules.

DE 10 2007 044 428 A1 discloses a spare wheel well for a motor vehicle that is inserted into an underbody structure of the motor vehicle by means of an angled flange. The spare wheel well is a plastic injection molding part and comprises at least one integrated hollow profile to increase the stiffness.

DE 10 2009 007 267 A1 discloses a catch element in the area of a stem of a body of a motor vehicle in which at least one module for the engine is arranged. The catch element is intended to catch a module moving backwards as a result of an accident-related application of force to the stem.

DE 10 2017 007 401 A1 discloses a motor vehicle that comprises at least one frame structure and at least one charging module arranged in a recess of the frame structure. A deformation device with at least one guide structure is surrounded by the frame structure, at least in regions, and absorbs accident-related deformation energy to protect a charging module.

DE 10 2018 205 878 A1 discloses a connection arrangement for a motor vehicle with two connection partners connected to each other via at least one connecting element. The connecting element comprises a base connected to a first connection partner. A web has one end connected to the base and engages through an opening in a second connection partner. A hook is at the other end of the web and engages behind the opening in the second connection partner. A catch connection is integrated into the connection element and connects the hook to the base.

Crash design for modern electric and hybrid vehicles requires that no high-voltage control devices or other electronic components or even passive components get into a vehicle battery because damage to individual battery cells could result in a fire. Furthermore, high-voltage components, such as high-voltage control devices should not be pushed into a passenger compartment and pose a risk for occupants. In addition, a high-voltage control unit should not leave the crash vehicle in an uncontrolled manner so that there is no danger to third parties at the scene of an accident.

Inductive charging devices are used increasingly with high-voltage batteries of electric vehicles or hybrid vehicles and are arranged on the vehicle underbody. Such inductive charging devices typically have an internal secondary coil that interacts with a stationary primary coil, for example installed in a garage or car park. The secondary coil receives electrical energy from the primary coil to charge the high-voltage battery. The secondary coil typically consists of a coil carrier made of non-ferromagnetic material, the inserted coil and ferrite bodies. To cool the coil, a cooling plate typically is placed on the upper side of the coil. The cooling plate can be cooled either actively (water-flow) or passively (air-cooled) depending on the performance. Cooling plates are stiff components that can be arranged on the underbody of an electric vehicle or hybrid vehicle in front of or behind the actual high-voltage battery viewed in the direction of travel. A cooling plate must not penetrate the high-voltage battery in the event of a vehicle crash. Such an inductive charging device not only poses a certain risk in the event of a crash as a comparatively rigid component, but depending on the high-voltage vehicle architecture, the inductive charging device can also be charged with electrical voltage, for example in DC link capacitors. Such charged electronic components can rupture in the event of a crash and thus the stored electrical energy poses a risk.

### SUMMARY OF THE INVENTION

The invention relates to configuring an inductive charging device in an electric vehicle or hybrid vehicle in such a way that the inductive charging device poses no risk to occupants of the motor vehicle or a battery, in particular a high-voltage battery, in the event of a crash. The electric vehicle or hybrid vehicle according to the invention has the aforementioned inductive charging device as well as a battery that can be charged with the charging device. According to the invention, the inductive charging device comprises at least one catch that connects the inductive charging device to a vehicle body. In addition, the inductive charging device is configured to be ejected from the electric vehicle or hybrid vehicle in the event of a crash and to be held outside the electric vehicle or hybrid vehicle via the at least one catch. The electric vehicle or hybrid vehicle minimizes crash effects for both vehicle occupants and for a battery of the electric vehicle or hybrid vehicle. In this regard, the charging device typically is installed in front of or behind the battery in the direction of travel, and also is arranged on the underbody of the electric vehicle or hybrid vehicle. The charging device is ejected reliably from the vehicle in the event of a crash and cannot penetrate into the battery or into a vehicle interior. In addition, the crash impulse is not changed (protection of the equipment variant). However, the catch of the inductive charging device is prevented from leaving the electric vehicle or hybrid vehicle in an uncontrolled manner in the event of a crash. Accordingly, the catch reduces the risk of components on the road being torn open or breaking open, and ensures that components of the inductive charging device that are still live, such as DC link capacitors, will not transmit their voltage and cause a fire. The electric vehicle or hybrid vehicle described herein and the inductive charging device and the catch can significantly reduce the consequences of an accident in the event of a crash, both for vehicle occupants and for the electric vehicle or hybrid vehicle. Uncontrolled ejection of the component can also be avoided, thereby reducing the risk to passersby and other road users. The retaining device also prevents the high-voltage line on the control unit from tearing off. Thus, a central active discharge (discharge of the DC link capacitors <60 Volt DC after a crash event) can also establish a safe state if the active discharge within the charging device is damaged in a crash.

The at least one catch may be configured as a catch strap made of metal or an electrical conductor. This makes it possible to establish an electrically conductive connection between the inductive charging device and the vehicle body, thereby earthing the inductive charging device. Alternatively, the catch can be made of plastic or other materials so that an electrical conductor is suitable for connecting the inductive charging device to the ground of the motor vehicle.

In a further embodiment, the inductive charging device has interconnected components that include: an electronic unit, a cooling plate and a bottom plate made of plastic, in particular glass fiber reinforced plastic. The electronic unit may control a charging operation of the battery and includes electronic components. The cooling plate can be made at least partially of aluminum and can be connected to a cooling circuit or an air-cooling system of the electric vehicle or hybrid vehicle to cool a secondary coil and/or other components arranged in the inductive charging device, thereby achieving a higher charging power and a shorter charging time. The secondary coil is covered at the bottom by the lower plate that provides underbody protection for the secondary coil. The individual components, i.e. the cooling plate, the electronic unit with its housing and the bottom plate, can be screwed, glued or welded together.

The electronic unit comprises a housing with a ramp or a phase configured so that the inductive charging device slides down from the vehicle via the ramp in the event of a crash. The chamfer or ramp on the housing of the electronic device thus causes the inductive charging device to be ejected downward out of the vehicle in the event of a crash, thereby preventing the inductive charging device from penetrating the battery or vehicle interior. Additionally or alternatively, the ramp or chamfer can be arranged on the vehicle body so interaction between the inductive charging device and the vehicle body causes the inductive charging device to be ejected or expelled in the event of a crash.

The housing of the electronic unit may be made of die-cast aluminum. This results in a very stiff configuration of the housing, whereby the ramp or chamfer of the housing causes the inductive charging device to be expelled reliably downward in the event of a crash.

The inductive charging device of some embodiments comprises holding arms via which the inductive charging device is screwed to the motor vehicle body, and the at least one catch element is screwed to the vehicle body with a first longitudinal end via one of the holding arms. Thus, the inductive charging device is fixed to the vehicle body via its holding arms, and no new fastening point needs to be created to fix the catch to the vehicle body, but an existing fastening to the holding arm of the inductive charging device is selected. In particular, this can also avoid an additional manufacturing step in the assembly of the inductive charging device on the electric vehicle or hybrid vehicle, as the catch is screwed to the vehicle body at the same time as the inductive charging device via its holding arms.

The inductive charging device of some embodiments comprises two front holding arms viewed in the direction of travel of the electric vehicle or hybrid vehicle and two rear holding arms viewed in the direction of travel. Two catches are provided and are screwed to the vehicle body with their respective first longitudinal end via an associated front holding arm. The two catches can prevent the inductive charging device from twisting or entangling in the event of a crash after it has been ejected from the electric vehicle or hybrid vehicle, thereby reducing the risk of damage to the inductive charging device. Separate production steps can also be dispensed with when two such catches, such as catch straps, are provided, as the catch straps are screwed to the vehicle body together with the inductive charging device via its front holding arms.

The inductive charging device can also comprise holding arms arranged on the right and left to account for design features of the motor vehicle. In general, tests have shown that it can make more sense to place a connection as far as possible towards the vehicle battery, as the screws cannot break off in the event of a crash.

The catch may be connected to the cooling plate or the electronic unit of the inductive charging device at a second longitudinal end, in particular welded, glued or screwed together. To reliably hold the inductive charging device on the electric vehicle or hybrid vehicle in the event of a crash after it has been ejected or expelled, it is necessary to connect at least one catch to the inductive charging device. Either the housing of the electronic unit or the cooling plate is suitable here, as both are made of aluminum, for example, and thereby have the necessary strength to catch the inductive charging device in the event of a crash.

Further important features and advantages of the invention will emerge from the dependent claims, from the drawings and from the associated description of the figures with reference to the drawings.

It is understood that the aforementioned features and the features yet to be explained in the following can be used not only in the respectively specified combination, but also in other combinations or on their own, without leaving the scope of the invention defined by the claims. The components mentioned above and the components mentioned below of a higher-level unit, such as a device, an apparatus or an arrangement, which are labeled separately, can constitute separate parts or components of this unit or can be integral regions or portions of this unit, even if shown otherwise in the drawing.

Preferred embodiments are shown in the drawings and are explained in further detail in the following description, wherein identical reference signs refer to identical, similar, or functionally identical components.

### BRIEF DESCRIPTION OF THE DRAWINGS

FIG. 1 is a cross-sectional view through an electric vehicle or hybrid vehicle according to the invention in the area of an inductive charging device.

FIG. 2 is a representation as in FIG. 1, but in the event of a crash.

FIG. 3 is a representation as in FIG. 2, but in the further course of the crash event with the ejected inductive charging device caught by the catch.

FIG. 4 is an oblique view of the inductive charging device.

FIG. 5 is a cross-sectional view through the inductive charging device.

### DETAILED DESCRIPTION

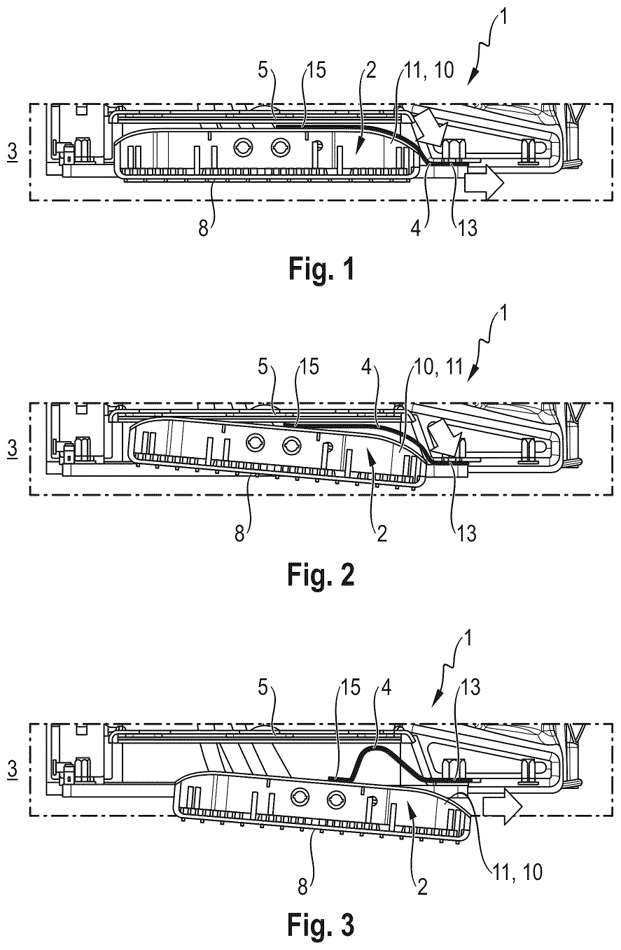

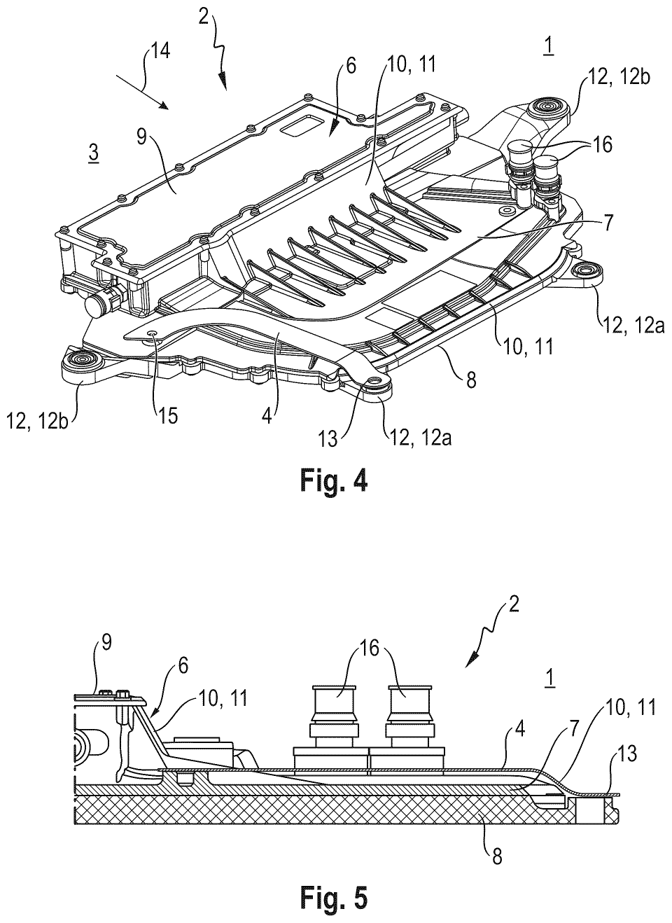

According to FIGS. 1 to 3, an electric vehicle or hybrid vehicle 1 according to the invention comprises an inductive charging device 2 (also compare with FIGS. 4 and 5) and a battery 3 that can be charged with this vehicle-mounted and thus mobile inductive charging device 2. The inductive charging device 2 comprises at least one catch 4, for example a catch strap, via which it is connected to a vehicle body 5. The charging device 2 is configured to be ejected down from the electric vehicle or hybrid vehicle 1 in the event of a crash, as shown in FIGS. 2 and 3, and at the same time is prevented from being ejected in an uncontrolled manner via the at least one catch 4. This offers two major advantages in the event of a crash. First, the downward ejection prevents the inductive charging device 2 from penetrating into the vehicle interior or the battery and thus destroying the battery cells, which in the worst case could lead to a fire or injury to the persons seated in the vehicle interior. Second, the catch 4 can hold the charging device 2 on the electric vehicle or hybrid vehicle 1, thereby reducing damage to the charging device 2 that occurs in the event of a crash and avoiding the risk of destroying the housing of live electrical components of the inductive charging device 2, such as DC link capacitors, which can reduce the risk of fire. Another particular advantage is that the catch 4 also can prevent the inductive charging device 2 from being ejected in an uncontrolled manner in the event of a crash, thereby reducing the consequences of accidents for other road users, such as pedestrians. Overall, the electric vehicle or hybrid vehicle 1 according to the invention can minimize the consequences of accidents both for vehicle occupants and for the electric vehicle or hybrid vehicle 1.

The at least one catch 4 can be configured as a catch strap, in particular made of metal, plastic or fabric. A metal configuration offers the advantage of electrically connecting the inductive charging device 2 to the earth of the motor vehicle. A metallic catch 4 also provides greater strength. Of course, plastic belts with or without internal electrical conductors are also conceivable.

The inductive charging device 2 comprises the following interconnected components: an electronic unit 6 (see FIGS. 4 and 5), a cooling plate 7 and a bottom plate 8 made of plastic, such as glass fiber reinforced plastic. The electronic unit 6 has a housing 9 with a ramp 10 or a chamfer 11. The ramp 10 or chamfer 11 is configured so that the inductive charging device 2 slides down from the electric vehicle or hybrid vehicle 1 in the event of a crash via the ramp 10 or the chamfer 11 and is ejected or expelled down from the vehicle. The interaction of the inductive charging device 2 with the motor vehicle body 5 in the event of a crash thus ensures that the inductive charging device 2 neither penetrates the vehicle interior nor the battery 3 in the event of a crash. This can protect both persons seated in the vehicle interior from injuries and the battery 3 from damage and, for example, a short circuit.

The housing 9 of the electronic unit 6 can be made of die-cast aluminum and can have the ramp 10 or chamfer 11 to cause the inductive charging device 2 to be ejected or expelled down in the event of a crash. In general, the ramp 10 or the chamfer 11 can also be arranged at a front end of the lower plate 8 viewed in the direction of travel 14. Several ramps 10 or chamfers 11 can be provided, as shown in FIGS. 4 and 5.

The inductive charging device 2 comprises holding arms 12 that are screwed to the vehicle body 5. The at least one catch element 4 is screwed to the vehicle body 5 with a first longitudinal end 13 via one of the holding arms 12, with the advantage that no additional bolting points and no additional manufacturing steps are required to fix the catch element 4. The inductive charging device 2 of FIG. 4 has two front holding arms 12a viewed in the direction of travel 14 and two rear holding arms 12b viewed in the direction of travel 14. Thus, two catches 4 can be provided (only a single catch 4 is shown in FIG. 4) and can be screwed to the vehicle body 5 with their respective first longitudinal end 13 via an associated front holding arm 12a. A second longitudinal end 15 of the catch 4 is connected to the cooling plate 7 or the electronic unit 6 of the inductive charging device 2, for example welded, glued or screwed. The cooling plate 7 made of aluminum also is coupled thermally to the bottom plate 8 or the secondary coil of the inductive charging device 2 arranged between the bottom plate 8 and the cooling plate 7. The cooling plate 7 can be connected to a cooling circuit or an air-cooling system of the electric vehicle or hybrid vehicle 1 via coolant nozzles 16.

The two catches 4 can also be screwed to the vehicle body 5 with their respective first longitudinal end 13 via an associated holding arm 12b. This is particularly advantageous if the front screws are sheared off in the event of a crash. When using the catch straps, it must be insured that they are long enough. The excess length of the catch straps is absolutely necessary to prevent them from being torn off.

The electric vehicle or hybrid vehicle 1 can significantly reduce the consequences of an accident occurring in the event of a crash, both for vehicle occupants of the electric vehicle or hybrid vehicle 1 and for a battery 3, since the inductive charging device 2, which is usually located in front of the battery 3 in the direction of travel 14, is designed to be ejected downwards from the electric vehicle or hybrid vehicle 1 via a corresponding ramp 10 or a corresponding chamfer 11 in the event of a crash. This reliably prevents unintended penetration of the inductive charging device 2 into the battery 3 or a vehicle interior in the event of a crash. The catch 4 disclosed herein can prevent the inductive charging device 2 that is ejected downwards in the event of a crash, from bursting or destroying in an uncontrolled manner and held on the vehicle 1 to prevent, for example, a rapid voltage discharge caused, for example, by destroyed DC link capacitors in the electronic unit 6, which can lead to a fire in the electric vehicle or hybrid vehicle 1 under certain circumstances

1. An electric vehicle or hybrid vehicle (1) comprising an inductive charging device (2) and a battery (3) chargeable with the inductive charging device (2), wherein:
the inductive charging device (2) comprises at least one catch (4) that connects the inductive charging device (2) to a vehicle body (5); and
the inductive charging device (2) is configured to be ejected from the electric vehicle or hybrid vehicle (1) in the event of a crash and to be held outside the electric vehicle or hybrid vehicle (1) via the at least one catch (4).

2. The electric vehicle or hybrid vehicle (1) of claim 1, wherein the at least one catch (4) is a catch strap made of metal.

3. The electric vehicle or hybrid vehicle (1) of claim 1, wherein the at least one catch (4) is a catch strap made of plastic.

4. The electric vehicle or hybrid vehicle (1) of claim 1, wherein the inductive charging device (2) comprises interconnected components that include: an electronic unit (6), a cooling plate (7) and a bottom plate (8) made from glass fiber reinforced plastic.

5. The electric vehicle or hybrid vehicle (1) of claim 4, wherein the catch (4) is connected to the cooling plate (7) or the electronic unit (6) of the inductive charging device (2) at a second longitudinal end (15).

6. The electric vehicle or hybrid vehicle (1) of claim 4, wherein the cooling plate (7) is made of aluminum and is connectable to a cooling circuit or an air cooling of the electric vehicle or hybrid vehicle (1).

7. The electric vehicle or hybrid vehicle (1) of claim 1, wherein the electronic unit (6) comprises a housing (9) having a ramp (10) or a chamfer (11) configured such that the inductive charging device (2) slides downwards from the electric vehicle or hybrid vehicle (1) via the ramp (10) or the chamfer (11) in the event of a crash.

8. The electric vehicle or hybrid vehicle (1) of claim 7, wherein the housing (9) is made of die-cast aluminum.

9. The electric vehicle or hybrid vehicle (1) of claim 1, wherein the inductive charging device (2) comprises holding arms (12, 12a, 12b) that are screwed to the vehicle body (5), the at least one catch (4) has a first longitudinal end (13) that is screwed to the vehicle body (5) via one of the holding arms (12, 12a).

10. The electric vehicle or hybrid vehicle (1) of claim 9, wherein the inductive charging device (2) comprises two front holding arms (12a) and two rear holding arms (12b) viewed in a direction of travel (14), and the at least one catch (4) comprises two catches (4) that are screwed to the vehicle body (5) with their respective first longitudinal end (13) via an associated front holding arm (12a).

11. The electric vehicle or hybrid vehicle (1) of claim 1, further comprising a housing (9) for receiving a stator power electronics unit, the housing (9) being formed from a non-magnetizable material.

12. The electric vehicle or hybrid vehicle (1) of claim 11, further comprising a protective coating arranged between the power electronics and an encapsulation material for protecting the power electronics.
